(19) United States
(12) Patent Application Publication
(10) Pub. No.: US 2026/0106901 A1
(43) Pub. Date: Apr. 16, 2026

(54) Techniques for Artificial Intelligence-Based Security Governance of Computing System Interfaces

(71) Applicant: TEACHERS INSURANCE AND ANNUITY ASSOCIATION OF AMERICA, New York, NY (US)

(72) Inventors: Phani Kotharu, Prosper, TX (US); Lucas Estrella, Charlotte, NC (US); Kapil Pruthi, Seattle, WA (US)

(21) Appl. No.: 18/917,015

(22) Filed: Oct. 16, 2024

(51) Int. Cl. H04L 9/40

(52) U.S. Cl. CPC H04L 63/20

(57) ABSTRACT

A computer-readable medium includes instructions for monitoring security compliance in a computing system. Operations may include generating an execution script to execute at least one function of an interface under multiple security policies. The function can be invoked by a device outside the computing system. The interface can include executable code segments that, when executed, access information within at least a portion of the computing system. Operations can further include executing the execution script to generate policy execution outputs. Operations may further include evaluating an extent to which the interface complies with a security policy associated with the computing system based on the policy execution outputs and providing an alert if the interface fails to comply with the security policy. A method and a system are also provided for performing these functions.

### FIELD OF THE INVENTION

The present aspects relate to computer security. More particularly, aspects of the disclosure are related to computer-implemented techniques to evaluate security risks posed by interfaces that access an organization's computer systems and networks.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Organizations implement governance measures of organizational computer systems, to include governance to enhance reusability, consistency, and trackability. However, data security and security breaches have become increasingly common. Data breaches can occur when malicious actors exploit weaknesses in an organization's infrastructure. For example, malicious code may be inserted into database software (e.g., a “SQL injection”) or when a hacker finds a software vulnerability or security flaw within other software code, into which the hacker can then inject malicious code. Hackers may also impersonate legitimate users to access computer systems and steal data or client identities. These and other types of breaches have led to billions of dollars in losses to both organizations and their clients.

Tools such as encryption can prevent some types of access, but encryption can fail and furthermore encryption does not prevent all types of access into computing systems. For example, some encryption may be subjected to brute force attack to decrypt the content. Furthermore, encryption is often developed separately from organizational software and may not account for all facets of organizational software design and access types. Therefore, there is a general need for improved security in the manner and level to which organizational computer systems are accessed.

### SUMMARY

In one aspect, a non-transitory computer-readable medium is provided that includes instructions that, when executed, cause a computer to perform operations including: (1) generating an execution script to execute at least one function of an interface under a plurality of security policies, the at least one function being invoked by a device outside the computing system and the interface comprising executable code segments that, when executed, access information within at least a portion of the computing system; (2) executing the execution script to generate policy execution outputs; (3) evaluating an extent to which the interface complies with the plurality of security policies associated with the computing system based on the policy execution outputs; and (4) providing an alert if the extent to which the interface complies with the plurality of security policies fails to meet a threshold and accessing a database to log the extent or details of the executing of the at least one function otherwise.

In another aspect, a computer-implemented method for monitoring security compliance in a computing system is provided. The method may include: (1) generating an execution script to execute at least one function of an interface under a plurality of security policies, the at least one function being invoked by a device outside the computing system and the interface comprising executable code segments that, when executed, access information within at least a portion of the computing system; (2) executing the execution script to generate policy execution outputs; (3) evaluating an extent to which the interface complies with the plurality of security policies associated with the computing system based on the policy execution outputs; and (4) providing an alert if the extent to which the interface complies with the plurality of security policies fails to meet a threshold and accessing a database to log the extent or details of the executing of the at least one function otherwise.

In yet another aspect, a computer system for monitoring security compliance in a computing system is provided. The computer system may include one or more processors and a memory storing computer-executable instructions that, when executed by the one or more processors, cause the one or more processors to: (1) generate an execution script to execute at least one function of an interface under a plurality of security policies, the at least one function being invoked by a device outside the computing system and the interface comprising executable code segments that, when executed, access information within at least a portion of the computing system; (2) execute the execution script to generate policy execution outputs; (3) evaluate an extent to which the interface complies with the plurality of security policies associated with the computing system based on the policy execution outputs; and provide an alert if the extent to which the interface complies with the plurality of security policies fails to meet a threshold and accessing a database to log the extent or details of the executing of the at least one function otherwise.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for security governance of computing system interfaces, according to some embodiments;

FIG. 2 depicts an exemplary data flow diagram for security governance of computing system interfaces, according to some embodiments;

FIG. 3 depicts a flow diagram of an exemplary policy execution flow, according to some embodiments;

FIG. 4 depicts a flow diagram of an exemplary risk evaluation flow, according to some embodiments; and

FIG. 5 depicts a flow diagram of an exemplary computer-implemented method for monitoring security compliance in a computing system, according to some embodiments.

While the systems and methods disclosed herein are susceptible of being embodied in many different forms, they are shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The detailed description that follows is directed to, inter alia, techniques for enhancing security governance in computer systems by monitoring security risks posed by interfaces that provide access into those computer systems. Some of these interfaces may be provided by software applications. An application programming interface (API) is a set of functions or procedures that allows software applications to access features of a computer system or computer-based product. In some instances, organizations and businesses can allow APIs to access, exchange, manage, or expose business data of the organizations and businesses.

In an API-first approach, an organization can develop organizational software with initial consideration to the APIs that access or use an organization's software, systems, or services. Under the API-first approach, software developers may develop APIs in an initial stage of a software development process, before writing other code. Many organizations consider governance at this initial stage of the software development process. Governance can include considering or implementing tools or operations meant to enhance reusability, consistency, and trackability. Some governance tools may examine API uniformity or whether an API has the expected structure (e.g., correct inputs and outputs, etc.). However, these tools are limited with respect to security. Still other governance tools verify deployment features, such as whether a cloud or other deployment is configured correctly, e.g., with correct firewall ports, etc. However, these solutions are not directed to API security governance.

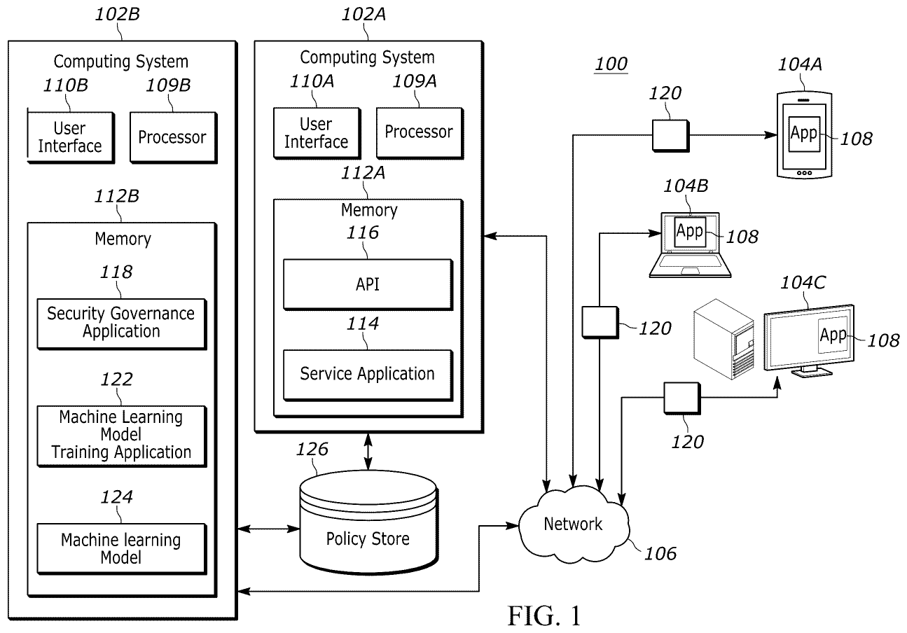

The security governance system described herein provides security governance to enhance overall organizational security. The techniques provided herein may be based on artificial intelligence or machine learning to perform risk prediction and analysis. Interfaces, including APIs, may be evaluated against security policies, provided in advance by the organization and retrieved from a policy store during machine learning model training or at other points during software development and execution. In the context of embodiments, interfaces or APIs comprise executable code segments that, when executed, access information within at least a portion of a computing system (e.g., computing system 102A, 102B (FIG. 1) or other organizational/enterprise computing system).

The techniques described herein address the critical need for preventing security breaches and data breaches, including loss of organizational information and an organization's client information, improving client perception of that organization. In addition, security policies may be updated as the organizational needs evolve, and as other potential threat sources are identified.

### Example System

Referring now to the drawings, FIG. 1 depicts an exemplary computer system 100 for security governance of computing system interfaces, according to some embodiments. The high-level architecture illustrated in FIG. 1 may include both hardware and software applications, as well as various data communications channels for communicating data between the various hardware and software components, as is described below.

The system 100 may include one or more computing systems 102A, 102B, etc., as well as, in some cases, one or more user computing devices 104A, 104B, 104C, etc., which may include, e.g., smart phones, tablets, laptops, virtual reality headsets, smart or augmented reality glasses, wearables, etc. The computing system(s) 102A, 102B, and user computing device(s) 104A, 104B, 104C, etc., may be configured to communicate with one another via a wired or wireless computer network 106.

Although two computing systems 102A, 102B, three user computing devices 104A, 104B, 104C, and one network 106 are shown in FIG. 1, any number of such computing systems 102A, 102B, user devices 104A, 104B, 104C, and networks 106 may be included in various embodiments. To facilitate such communications the computing systems 102A, 102B and user computing devices 104A, 104B, 104C may each respectively comprise a wireless transceiver to receive and transmit wireless communications.

The user computing device(s) 104A, 104B, 104C may each include, or may be configured to communicate with, a user interface, which may receive input from users and may provide audible or visible output to users. Furthermore, the user computing device(s) 104A, 104B, 104C may each include one or more processor(s), as well as one or more computer memories. The memories of the user computing device(s) 104A, 104B, 104C may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) of the user computing device(s) 104A, 104B, 104C may store an operating system (OS) (e.g., iOS, Microsoft Windows, Linux, UNIX, etc.) capable of facilitating the functionalities, apps, methods, or other software as discussed herein. The memorie(s) of the user computing device(s) 104A, 104B, 104C may also store a web browser via which a user can access a service provided by the organization that owns the computing systems 102A, 102B, or via which a user can operate or access a user application 108 that access the computing system 102A.

The computing systems 102A, 102B may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 109A, 109B (e.g., CPUs) as well as one or more computer memories 112A, 112B. While the computing systems 102A, 102B are shown as two separate systems, the computing systems 102A, 102B can operate on a single computing system or on more than two computing systems. Either or both computing systems 102A, 102B can further include a user interface 110A, 110B to display alerts, provide audible alarms, or other indications as described later herein. The user interfaces 110A, 110B may be provided in whole or in part on a display monitor (e.g., LCD screen, touch screen, or any other type of display), and can incorporate an integrated or separate sound system.

Memories 112A, 112B may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 112A, 112B may store an operating system (OS) (e.g., Microsoft Windows, Linux, UNIX, etc.) capable of facilitating the functionalities, apps, methods, or other software as discussed herein. Memory 112A may store a service application 114 and an API 116, described in more detail later herein,

Executing the service application 114 may include providing an online service or web-based service (such as a banking service, an investment service, etc.) accessible by the various user devices 104A, 104B, 104C, etc. from outside either of the computing systems 102A, 102B. For instance, the service application 114 may receive user inputs, data, etc., sent to the computing system 102A by the various user devices 104A, 104B, 104C, etc. (e.g., via respective user applications 108 executing on the various user devices 104A, 104B, 104C, etc., and/or via web browser applications executing on the various user devices 104A, 104B, 104C, etc.).

A device (e.g., device/s 104A, 104B, and/or 104C) can invoke at least one function of an interface (e.g., API 116) from outside the computing system 102A. The user devices 104A, 104B, 104C can provide inputs to the function (or to multiple functions of one or more APIs) during this function invocation. The API(s) 116 can access the computing system 102A through gateway component(s) described in more detail later herein. The service application 114 can execute the at least one function and generate policy execution outputs (described later herein) as outputs of this execution. The service application 114 may take various actions based on the user inputs, data, etc. provided via the APIs 116. Furthermore, the service application 114 may send data to the respective user devices 104A, 104B, 104C. In particular, the service application 114 may manage accounts associated with particular users, including sensitive and/or otherwise private data associated with particular users.

The service application 114 may include various portions, areas, sections, etc., some of which are more secure portions, areas, sections, etc., associated with more private and/or sensitive user data and others of which are associated with less private, less sensitive, and/or more generally available data. For example, the private and/or sensitive user data may include financial data such as amounts of user money in various banking and/or investment accounts, user banking or credit account numbers, and/or user financial history, as well as user identifying data such as user contact information (e.g., phone numbers, addresses, etc.), user social security numbers, user passport or drivers' license numbers. Accessing the more secure portions, areas, sections, etc., of the online service using credentials for a particular user account may allow a user to view the private and/or sensitive user data associated with that account via the various user devices 104A, 104B, 104C, etc., and furthermore, may allow a user to modify the private and/or sensitive user data associated with that account via the various user devices 104A, 104B, 104C, etc., or make various other account selections, decisions, or inputs, such as input to proceed with a transaction or transfer, make an investment, etc. Accessing the less secure and/or less private, portions, areas, sections, etc., may allow a user to view, for instance, contact information for a customer support specialist associated with the online service, open or available hours associated with the service. Furthermore, in some examples, accessing the less secure and/or less private portions, areas, sections, etc., may allow a user to view account data without modifying or updating the data, and/or without making any selections associated with the account data.

Memory 112B can store a security governance application 118, evaluation components 120 such as an API gateway, a Domain Name System (DNS) resolution component, a continuous integration and continuous deployment (CI/CD) pipeline, or similar components through which API function call(s) may be made into the computing system 102A, a machine learning model training application 122, and/or one or more machine learning model(s) 124. A policy store 126 may store security policy data from various sources. For instance, software developers, management, a third-party security company, etc. can provide the security policy data to the computing systems 102A, 102B for storage in the policy store 126 (or in memories 112A, 112B). The policy data may include a list (versioned or otherwise) of security policies that are evaluated to assess security posture and risk of an API, as discussed later herein.

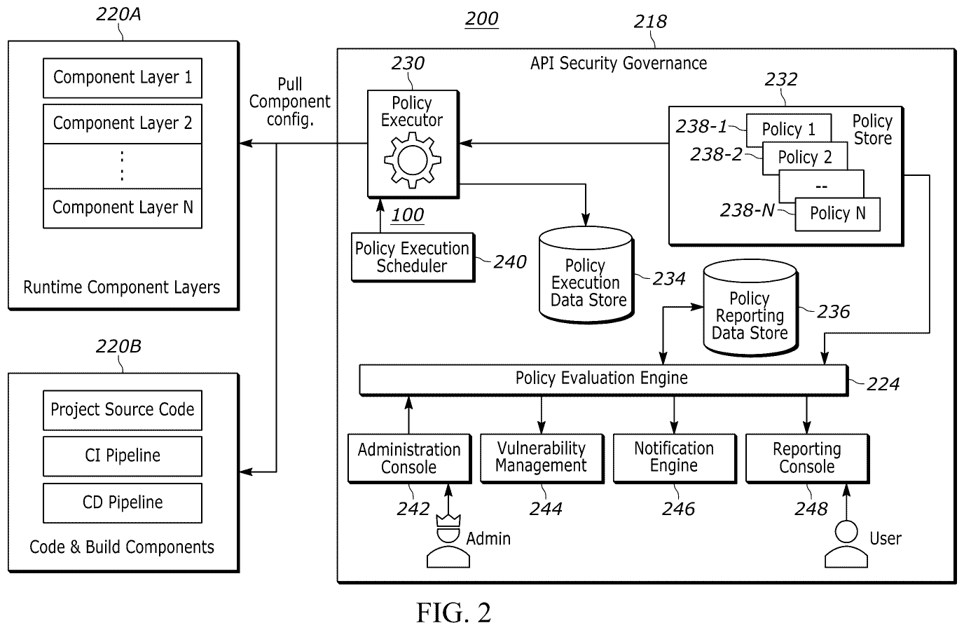

Executing the security governance application 118 may include executing security policies stored in the policy store 126. The security governance application 118 can evaluate the extent to which an interface (e.g., API 116) complies with the security policies based on policy execution outputs provided by the service application 114 as described above. The security governance application 118 can generate an alert, to be displayed or provided to, e.g., the user interface 110A, 110B, if the security policy compliance fails to meet a threshold. Further description of the structure of the security policies and execution of the security governance application is provided later herein with reference to FIG. 2.

The evaluation components 120 can include one or more of an API gateway, a Domain Name System (DNS) resolution component, a continuous integration and continuous deployment (CI/CD) pipeline, or any other similar hardware or software component, pipeline, or gateway that can include an API or that can execute (e.g., “run”) an API. By way of explanation of the listed gateway components, an API gateway provides an entry to a service (e.g., services provided by the computing system 102A), and performs functions such as routing, authentication, traffic control, security, and caching based on requests from one or more APIs (e.g., API 116). A DNS maps IP addresses to hosts connected to either a public or private internet via a DNS resolution process. CI/CD pipelines can deliver code to web hosting environments and/or other cloud computing platforms. Some CI/CD pipelines may be specific to a single application and may be used to provide updates or patches to applications or to test applications.

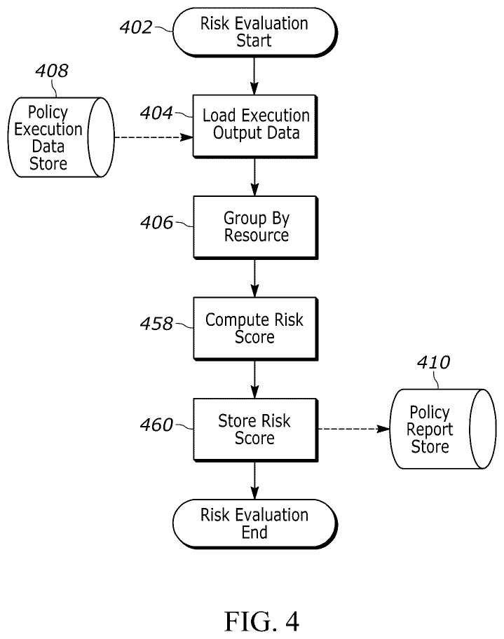

The computing system 102B may use machine learning models 124 to predict a security risk score of a new API (e.g., an API under development or a new version of a previous/historical API) based on characteristics of the new API and an output of an execution instance of the new API. For example, a machine learning model 124 trained to predict the security risk score of an API may be trained by a machine learning model training application 122 using training data including security risk scores of a plurality of APIs (e.g., historical interfaces/APIs or previous version of interfaces/APIs), outputs of execution instances of the plurality of interfaces, and characteristics of the plurality of interfaces. The outputs of execution instances may be retrieved or provided from, for example, policy execution data store 408 (FIG. 4). Characteristics of the plurality of interfaces are described later herein with respect to FIG. 4. The machine learning model 124 can therefore be trained to predict how characteristics of an API can affect security risk scores of the API.

In some examples, the machine learning model 124 may be executed on the computing system 102B, while in other examples machine learning model 124 may be executed on another computing system, separate from the computing system 102B. For instance, the computing system 102B may provide, transmit, or send training data (e.g., training data described above including security risk scores of a plurality of interfaces, outputs of execution instances of the plurality of interfaces, and characteristics of the plurality of interfaces) to the other computing system and the other computing system can execute machine learning model(s) 124 based on the training data and provide predictions or other results back to the computing system 102B. Moreover, in some examples, the machine learning model(s) 124 may be trained by a machine learning model training application 122 executing on the computing system 102B, while in other examples, the machine learning model 124 may be trained by a machine learning model training application 122 executing on another computing system, separate from the computing system 102B.

Whether the machine learning model(s) 124 is/are trained on the computing system 102B or elsewhere, the machine learning model(s) 124 may be trained by the machine learning model training application 122 using the training data (described above (e.g., security risk scores of a plurality of APIs, outputs of execution instances of the plurality of interfaces, and characteristics of the plurality of interfaces). The trained machine learning model(s) 124 may then be applied to new APIs (e.g., APIs still undergoing design or development, recently designed APIs or similar source code or single functions within the APIs) to predict security risk scores of the new APIs. If a new API is predicted to have a high security risk score, then characteristics of the API may be changed or modified (by, e.g., code changes, recompilation, etc.).

The computing system 102B can automatically generate recommendations for interface modification or computing system modification based on the security risk score of the new interface. For example, if machine learning models have predicted a particular interface characteristic is more likely to cause or indicate security concerns, the computing system 102B can generate a recommendation that the interface characteristic should be removed from later versions of the interface, or not implemented in new interfaces. Interface modifications can include changes to the source code of one or more interfaces, changes to security measures (e.g., addition of authentication procedures), and the like.

Additionally or alternatively, because outputs of the machine learning model 124 indicate how characteristics of an API affect security risk, the outputs may be stored or provided to software developers and development managers to recommend improvements in API development and general software development with a view to reducing future security risks. Software developers, management, or other parties can provide feedback regarding effectiveness of suggestions, accuracy of predictions, and the like. The feedback may be provided to machine learning algorithms to improve predictions.

The computing system 102B, when implementing risk evaluation as described later herein with reference to FIG. 4, can use machine learning models 124 to predict severity levels of the security effects produced by violating a security policy. For example, a machine learning model 124 trained to predict severity a severity level may be trained by a machine learning model training application 122 using training data including include severity of the effects of violating each of the one or more security policies, which may be observed and manually or automatically logged during laboratory testing of the computing system 102A, 102B (FIG. 1) or provided as bug reports or incident reports after system deployment. Training data can further include characteristics of security policies (e.g., characteristics seen in Table 1 later herein), which may be retrieved from the policy store 232 (FIG. 2). The machine learning model 124 can therefore be trained to predict how characteristics of a security policy can affect severity of the effects of violating the security policy. The severity may be used to assign weights for generating weighted sums described later herein with reference to FIG. 4.

In various aspects, the machine learning model 124 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. The machine learning model(s) 124 may be or may include a multimodal (e.g., text, audio, video, image, etc.) language model, and may be a small language model, a large language model, and/or a hybrid language model in various embodiments for purposes of model efficiency and/or specificity.

In some embodiments, the artificial intelligence and/or machine learning based algorithms used to train the machine learning model(s) 124 may comprise a library or package executed on the computing system 102B (or other computing devices not shown in FIG. 1). For example, such libraries may include the TENSORFLOW based library, the PYTORCH library, and/or the SCIKIT-LEARN Python library.

Machine learning may involve identifying and recognizing patterns in existing data (such as training a model based upon historical API data or current/historical security policies) in order to facilitate making predictions for subsequent data (such as using the machine learning model 124 on new API data or characteristics to determine a likelihood that the new API will fail to comply with one or more security policies). Other machine learning model(s) 124 may be used for other purposes such as predicting severity of risk of violating new security policies under development, based on a variety of factors. Further detail regarding training of machine learning model(s) 124 is provided in discussion of FIG. 4 later herein.

Machine learning model(s) may be created and trained based upon example data (e.g., “training data”) inputs or data (which may be termed “features” and “labels”) to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

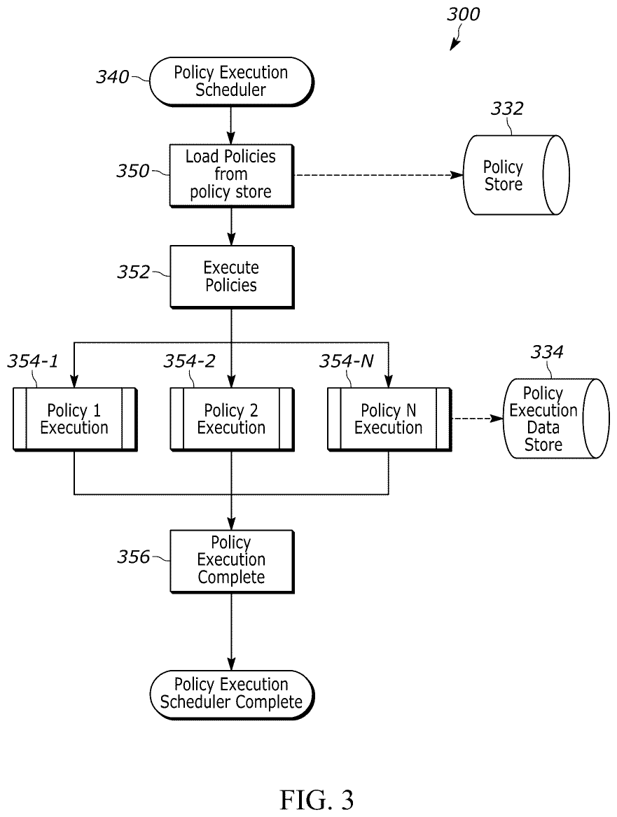

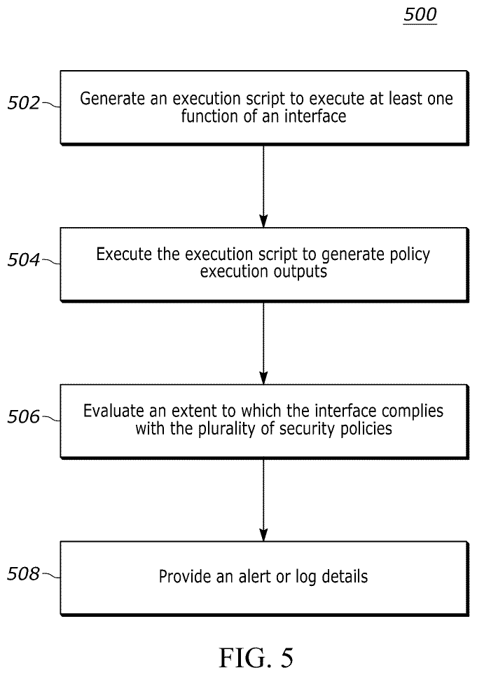

In addition, memories 112A, 112B may store additional machine readable instructions (on a non-transitory computer-readable medium or media), including any of one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memories 112A, 112B may include instructions for carrying out any of the operations discussed with respect to the schematic diagram 200 shown at FIG. 2, and/or any of the operations of the policy execution flow 300 (which is described in greater detail below with respect to FIG. 3), and/or any of the operations of the risk evaluation flow 400 (which is described in greater detail below with respect to FIG. 4), and/or any of the operations of the method 500 for security governance (which is described in greater detail below with respect to FIG. 5) via algorithms stored on the memories 112A, 112B and executing on the processors 109A, 109B. It should be appreciated that one or more other applications may be envisioned and that are executed by the processor(s) 109A, 109B.

### Example Data Flow Diagram

FIG. 2 depicts an exemplary data flow diagram 200 for security governance of computing system interfaces, according to some embodiments. Some components of the data flow diagram 200 can be implemented in components of the computer system 100 (FIG. 1). For example, a security governance system 218 may be executed within a security governance application 118 or other component of computing system 102A or computing system 102B. A policy executor 230 can also be executed with the security governance application 118. The policy store 232, policy execution data store 234, and policy reporting data store 236 may be stored within policy store 126 (FIG. 1). A policy evaluation engine 224 can derive risk scores for components based on execution of policies, using either weighted sums or other calculations described later herein or using use one or more machine learning model(s) 124. Runtime components 220A and code and build components 220B may be provided within evaluation components 120.

The policy executor 230 can execute various security policies stored in the policy store 232 (described in more detail below). The execution may be serial (e.g., sequential) or parallel (e.g., simultaneous) depending on the dependencies between policies as described later herein. The policy executor 230 can define execution based on the dependency of the policies and on available computational resources (e.g., worker threads or other execution/worker resources) of the policy executor 230. Policy execution outputs can be stored as described in more detail later herein with respect to the policy execution data store 234.

The policy store 232 can maintain a versioned list of security policies that are to be evaluated to assess the security posture and residual risk of an API. A security policy 238-1, 238-2, . . . , 238-N can comprise or include a rule or a condition to be met by an API to comply with an organization/enterprise security standard. The security policy may be associated with a hardware or software component (e.g., runtime components 220A, project source code and/or CI/CD pipeline components 220B, or any other component that could be included in evaluation components 120 (FIG. 1)) that can constitute an API, that is responsible for executing (e.g., “running”) an API, or within or through which an API can execute. A security policy 238-1, 238-2, . . . , 238-N can include various data fields or metadata that an API security governance system can use for execution, evaluation, and reporting. Some example fields of a security policy 238-1, 238-2, . . . , 238-N are shown below in Table 1:

| Field Name | Description | Example Value |
|---|---|---|
| Policy Version | Version of policy | 1.0 |
| Kind | Type of policy | Security governance |
| Name | A human friendly name of the policy | “Secure hyperlink link policy” |
| Description | A detailed description of the policy | API should use a secure |
| | | protocol and should not be |
| | | exposed over an insecure |
| | | protocol for internal and |
| | | external traffic |
| Severity Level | Indicates severity or security risk to | Critical |
| | the enterprise of not complying with | |
| | the policy | |
| Component name | Name of the component against | API Gateway |
| | which this policy will be evaluated | |
| Component | A script or an API call used to query | |
| execution command | the component to retrieve | |
| | information and evaluate a policy | |
| | condition | |
| Component | Hostname of host that holds a | |
| resource | component resource | |
| identification | | |
| Remediation steps | Contains the operations on how to | Do not expose or consume |
| | be compliant with this policy, for | APIs using non-secure |
| | example what needs to be done to | protocols, use only secure |
| | bring an API into compliance | endpoints |
| External Link | Link to a site where the policy code | |
| | or other information can be found | |
| Enabled | Whether the policy is enabled for | |
| | execution (e.g., true/false) | |
| Tags | For categorizing and filtering | |
| | different policies | |

A policy execution scheduler 240 can schedule policy execution based on a schedule (e.g., a predetermined schedule either provided by a software team, management, or quality assurance teams). Execution can additionally or alternatively be triggered by a trigger event (e.g., a periodic trigger or upon detection of a security breach, new software version, etc.), as a batch job to execute more than one policy, or on an on-demand basis.

The policy execution data store 234 can store outputs of each policy execution (e.g., “policy execution outputs”). Outputs of the policy execution data store 234 may be provided as inputs to the policy evaluation engine 224 as described in more detail later herein. Outputs can include multiple snapshots of execution data for historical analysis and tracking component level changes over time. Execution data can include data regarding network traffic (e.g., if large or unexpected bursts of traffic are shown, this can indicate a security policy violation or an indication that a new security policy should be developed), data regarding which memory or applications are accessed within the computing system (e.g., computing system 102A or other server), information regarding the type of access (e.g., read/write access) made, and other parameters and data pertinent to execution of service applications and APIs.

The policy evaluation engine 224 can evaluate output of each policy execution to derive a composite risk score for each component (e.g., runtime components 220A and code and build components 220B, which can include any components described with reference to evaluation components 120 earlier herein, although embodiments are not limited to the specific components listed). The policy evaluation engine 224 can aggregate a score for an API based on the components used by each respective API to derive an API risk score for each respective API. The policy evaluation engine 224 stores results of evaluation in the policy reporting data store 236.

Results stored in the policy reporting data store 236 may be formatted into display notifications, recommendation text, alarms, warnings, and other outputs by the administration console 242, vulnerability management system 244, the notification engine 246, and/or the reporting console 248. The administration console 242, vulnerability management system 244, the notification engine 246, and the reporting console 248 can proactively retrieve API risk score details from the policy reporting data store 236. The vulnerability management system 244 can integrate with an enterprise/organization vulnerability management process and system to generate change requests and proactively recommend modifications to APIs or other recommendations based on the criticality of detected security gaps in the APIs, functions therein, or components. The notification engine 246 can generate alerts, emails, and other automated or manual types of alerts to software developers, management, and other stakeholders. The notification engine 246 can interface with off-the-shelf or proprietary software development tools and bug-tracking systems/software. The administration console 242, the vulnerability management system 244, the notification engine 246, and the reporting console 248 may be provided in organization devices separate from the security governance system 218.

### Example Policy Execution

FIG. 3 depicts a flow diagram of an exemplary policy execution flow 300 according to some embodiments. Generally speaking, similar elements are labeled with similar reference numbers that share two least significant digits, with differences discussed below where appropriate. For example, policy execution scheduler 340 in FIG. 3 is similar to policy execution scheduler 240 in FIG. 2. With the exception of the differences shown in the figures and discussed below, any of the other implementations discussed with respect to a particular element (e.g., for data flow and other functionality) may apply to elements with similar reference numbers in other figures.

The policy execution scheduler 340 can instruct a policy executor (not shown in FIG. 3) to load policies from the policy store 332 as defined by the policy execution scheduler 340, at operation 350. Policies may be executed in a serial or parallel form based on dependencies of outputs of each security policy 238-1, 238-2, . . . , 238-N or based on computing resources of the policy executor (e.g., policy executor 230 (FIG. 2)). For example, if a policy does not have a dependency on the output of other policies, that policy may be executed in parallel with any other policy. Policy loading can include fetching the most recent (e.g., latest) active security policies from the policy store 332.

At operation 352, the policy executor can execute policies according to sequences describe above (e.g., in parallel or serially). Policies that are dependent on the outputs of other policies are sequenced to execute after the respective other policy/policies execute/executes. The policy executor queues the various polices based on the dependencies and tracks the progress of policy execution.

At operation/s 354-1, 354-2, . . . 354-N, individual policy execution can include executing a component-specific execution command. For example, the command may be a script to be run on the component (e.g., one or more of the runtime components 220A (FIG. 2), code and build components 220B (FIG. 2), or evaluation components 120 (FIG. 1)) or an API that is to be invoked on the respective component. Operation/s 354-1, 354-2, . . . 354-N can connect to a respective component/s through a service account or through an API access mechanism to execute the command.

Pseudocode for a policy execution with respect to an API gateway component is shown in Table 2.

TABLE 2
pseudocode for policy execution

```
For each route in a gateway:
  Does the route comply with a policy to only pass APIs
that use a secure version of a hypertext transfer protocol?
  If not, log a failure, otherwise log success
```

While one example policy is shown in Table 2, testing can be done against a different policy and/or testing can be done against several policies. Similar policy executions can be performed for other types of components (e.g., any type of evaluation component 120 (FIG. 1), runtime component 220A (FIG. 2), or code and build component 220B (FIG. 2)), and embodiments are not limited to a particular component or a particular mode of policy execution. Further, other features of gateways and configurations of gateways can be examined, and other gateway routes can be examined. For example, examination and execution of policies can be performed regarding upstream services and APIs upstream of the gateway, ingresses, and other types of access to features and services of the gateway. Further, similar policy execution can be designed for other types of components, such as other runtime components and code/build components (e.g., project source code and CI/CD components).

Each policy execution can result in output of an execution log to be used in future operations to debug execution of the command. Output is further stored in the policy execution data store 334. The output can include a timestamp or other feature to be used by in further analysis operations such as can be performed by, e.g., a policy evaluation engine 224 (FIG. 2) to determine risk scores (e.g., component-level risk scores and API-level risk scores).

At operation 356, policy execution (or one iteration of policy execution) is complete. Policy execution can be re-started at a later time based on a schedule, trigger, or on-demand request, etc. The policy executor (not shown in FIG. 3) can summarize the execution of some or all of the polices that were executed during the execution flow. The summary can indicate successful execution of the policies and failures of the policies. Failure and success can be determined/recorded based on, for example, failure or success in meeting requirements of a policy, as described with reference to Table 1 and Table 2 earlier herein.

### Example Risk Evaluation

Referring now to FIG. 4, a risk evaluation flow 400 comprises analyzing policy execution output data. Generally speaking, similar elements are labeled with similar reference numbers that share two least significant digits, with differences discussed below where appropriate. For example, policy execution data store 408 in FIG. 4 is similar to policy reporting data store 236 in FIG. 2. With the exception of the differences shown in the figures and discussed below, any of the other implementations discussed with respect to a particular element (e.g., for data flow and other functionality) may apply to elements with similar reference numbers in other figures

The risk evaluation flow 400 can include machine learning and/or artificial intelligence-based methods although embodiments are not limited thereto. Risk evaluation includes evaluating policy execution outputs, aspects and features of the components analyzed (e.g., runtime components 220A (FIG. 2), code and build components 220B (FIG. 2), or evaluation components 120 (FIG. 1), characteristics of interfaces (e.g., APIs), and other data.

Characteristics of the APIs can include one or more of: whether function(s) of the APIs are overloaded and/or include default parameters, whether the functions of the API read or write data, level of security (e.g., whether authentication is required to access APIs and their function(s)), which resources are accessed in the computing system 102A and the level of protection desired for the accessed resource(s), parameter types of the function(s) in the API, etc. For example, if an API only performs read functions, security threats may be lower compared to cases in which the API has both read and write access. As an additional example, APIs that include their own authentication features may be of less risk than APIs that have no authentication procedures. As still another example, APIs expected to access less secure portions of the computing system 102A may be predicted to have a lower security threat than those having access to private data or more secure portions of the computing system 102A.

Risk evaluation flow 400 can be triggered at operation 402 at the end of policy execution flow 300 (FIG. 3), as a scheduled batch job, or on an ad hoc basis by the API security governance administrator. Output of the policy execution data store 408 can be provided as a feature set into an AI based system or other system type or algorithm for computing the risk score at operation 404. In operation 406, because policy execution output data can include data of multiple components and of multiple interface (e.g., API) resources, the risk evaluation flow 400 can group output data based on the interface resource to calculate the risk score per interface.

Risk evaluation flow 400 can include operation 458 to compute a risk score for an interface or API. In some examples, risk scores can be computed through summations. For example, operation 458 can include generating a weighted risk score by generating a weighted sum of extents to which the interface (e.g., API) complies with one or more of the security policies (e.g., the one or more security polices executed at operation 352 (FIG. 3)). A weight can be defined for each element of the weighted sum based on a severity of a risk associated with violating each respective security policy. For example, if violating a first security policy would cause severe data breaches, the first security policy may be assigned a very high weight. As a further example, if violating a second security policy would allow an API access to less sensitive user data, then the second security policy may be assigned a medium weight. As yet another example, if violating a third security policy would allow an API read-only access to data or applications, then the third security policy may be assigned a lower weight than a fourth security policy that allowed read-write access to data or applications. Weights can be assigned manually or automatically, or weights can be predicted/learned using machine learning model 124 as described in more detail below. The risk store can be stored in operation 460 within the policy report store 410. Additionally or alternatively, operations 400-458 can be implemented using machine learning as described above with reference to FIG. 1.

### Example Method

FIG. 5 depicts a flow diagram of an exemplary computer-implemented method 500 for monitoring security compliance in a computing system, according to some embodiments. One or more operations of the method 500 may be implemented as a set of instructions stored on a computer-readable memory (e.g., memory 112A and/or or memory 112B) and executable on one or more processors (e.g., processor 109A, 109B). For example, some operations may be executed by a service application 114, an API 116, and a security governance application 118.

The method 500 may begin at operation 502 with the security governance application 118 generating an execution script to execute at least one function of an interface under a plurality of security policies. This function may be invoked from outside the computing system 102A, 102B, for example, the function may be invoked from a device (e.g., device/s 104A, 104B, and/or 104C). The interface (which can comprise for example API 116) can comprise executable code segments that, when executed, access information within at least a portion of the computing system. A security policy can comprise a rule or a condition to be met by the interface, as shown and described above with reference to Table 1 and Table 2. As similarly shown in Table 1 and Table 2, a security policy can be associated with a component within which or through which the interface executes. As described earlier herein, the component can include an API gateway, a DNS resolution component, a CI/CD pipeline, or other components. In some example embodiments, the interface can comprise an API or portion thereof. For example, an API may include a plurality of functions, which may or may not be overloaded to include various types of parameters, which may or may not include default parameters.

Generating the execution script can comprise determining dependencies between a first policy of the execution script and a second policy of the execution script. For example, if any input, function, or other feature of a second policy relies on an output or result of execution of the first policy (or on any other aspect of the first policy, such as input parameters, processing, data, etc.), then the second policy cannot be run at the same time as the first policy. Therefore, the execution script can be generated such that the first policy and the second policy execute simultaneously or sequentially depending on whether there are dependencies between the first policy and the second policy. The execution script includes policies that correspond to more than one component (e.g., any two or more the evaluation components 120 (FIG. 1), runtime components 220A, and code and build components 220B, and any combination thereof). The execution script can also include policies that correspond to more than one interface (e.g., policies can be applied to more than one API, and an API can be executed and evaluated with respect to more than one policy).

The method may continue with operation 504 with a service application 114 executing the executing script. Operation 504 can generate policy execution outputs. The method 500 may continue with operation 506 with a security governance application 118 evaluating an extent to which the interface complies with security policies associated with the computing system based on the policy execution outputs.

The method 500 can include obtaining training data including outputs of execution instances of a plurality of interfaces, characteristics of the plurality of interfaces, and a security risk score for each of the plurality of interfaces. The method 500 can include training a machine learning model, using the training data, to predict a security risk score of a new interface based on characteristics of the new interface and an output of an execution instance of the new interface. The training and training data can be as described earlier herein with reference to FIG. 3 and FIG. 4.

The method 500 can further include providing a recommendation for interface modification or computing system modification based on the security risk score of the new interface. The recommendation can be provided in a text output or graphical output to the user interface 110A, 110B and/or the recommendation can be provided to a separate software development tool, via email, or any other separate or integrated alert or communication system.

As described earlier herein, recommendations can include recommendations to change (and recompile or deploy) the source code one or more APIs, change security parameters and algorithms, etc., and these recommendations can be provided to manual or automated software development tools, to development managers, or to other stakeholders. Recommendations can further include recommendations to the overall computing system or component thereof, to block access of one or more APIs, including historical interfaces (e.g., previously-developed APIs and versions thereof) and new interfaces or APIs under development. Some of the above recommendations can be automatically implemented in the service application 114 or the evaluation components 120. For example, some recommendations to block an API can be configured to trigger automatically upon detection of a severe security risk by code changes to the service application 114 to not permit API access or to remove the ability for an API to call into the service application. As an additional example, evaluation components 120 could undergo configuration changes implemented by component providers or by the organization itself, to no longer allow API access to the computing system 102A. As a still further example, firewalls or other devices could be provided at the network to block access by an API or type of API. Recommendations can be made based on API characteristics. For example, if an API has a number of overloaded functions, recommendations can be suggested for each version of a function, or only for versions of the function with certain parameter types.

The method 500 can comprise evaluating the extent to which the interface complies with a plurality of security policies. A weighted risk score can be generated that by taking a weighted sum of extents to which the interface complies with the plurality of security policies. The weight for each element in the sum can be defined based on the severity of risk associated with violating each respective security policy. The method 500 can include generating or determining the weights to be used with machine learning as described earlier herein with reference to FIG. 4, obtaining training data including results of executing a plurality of interfaces against one or more security policies, and a severity of effects of violating each of the one or more security policies. The method 500 can include training a machine learning model, using this training data, to predict a security risk score of a new interface based on characteristics of the new interface and an output of an execution instance of the new interface. For example, if the new interface shares many characteristics with interfaces discovered to be high-risk, the new interface may be determined to also be of high risk. Conversely, if a new interface shares few characteristics with historically high-risk interfaces, or if the new interface shares many characteristics with historically low-risk interfaces, the new interface may be determined to be low risk. Data regarding the detected or predicted risk can be provided for display, or to automated and manual software development tools.

The method 500 may continue with operation 508 by providing an alert if the extent to which the interface complies with the security policies fails to meet a threshold and accessing a database to log the extent or details of the executing of the at least one function otherwise. The alert can be provided to a user interface 110A, 110B (FIG. 1). The threshold can be “zero tolerance” in the sense that no violation of security policies is tolerated. In another example, the threshold can be on a policy-by-policy basis, wherein violation of more security polices always causes an alert to be generated, regardless of the extent of violation. By way of additional example, violation of some security policies may trigger informational logging only. This can be the case for lab testing situations wherein the computing system 102A and security policies are tested within the organization before final release of interfaces or APIs.

### Aspects

Aspects of the techniques described in the present disclosure may include any of the following aspects, either alone or in combination:
1. A computer-readable medium including instructions that, when executed on a processor, cause the processor to perform operations for monitoring security compliance in a computing system, the operations comprising: executing at least one function of an interface, the at least one function invoked by a device outside the computing system, to generate policy execution outputs, the interface comprising executable code segments that, when executed, access information within at least a portion of the computing system; evaluating an extent to which the interface complies with a security policy associated with the computing system based on the policy execution outputs; and providing an alert if the extent to which the interface complies with the security policy fails to meet a threshold and accessing a database to log the extent or details of the executing of the at least one function otherwise.
2. The computer-readable medium of aspect 1, wherein: the security policy comprises a rule or a condition to be met by the interface; and the security policy is associated with a component within which or through which the interface executes.
3. The computer-readable medium of aspect 2, wherein: the interface comprises an application programming interface (API) or a portion thereof; and the component comprises an API gateway.
4. The computer-readable medium of any of aspects 2-3, wherein the component comprises a Domain Name System (DNS) resolution component.
5. The computer-readable medium of any of aspects 2-4, wherein the component comprises a continuous integration and continuous deployment (CI/CD) pipeline.
6. The computer-readable medium of any of aspects 2-5, wherein the operations further comprise: generating an execution script to execute at least one interface under a plurality of security policies; and determining security compliance of the at least one function of the interface throughout execution of at least a portion of the execution script.
7. The computer-readable medium of aspect 6, wherein: generating the execution script comprises determining dependencies between a first policy of the execution script and a second policy of the execution script; and generating the execution script such that the first policy and the second policy execute simultaneously or sequentially depending on whether there are dependencies between the first policy and the second policy.
8. The computer-readable medium of aspect 6, wherein: the execution script includes policies that correspond to more than one component.
9. The computer-readable medium of aspect 6, wherein: the execution script includes policies that correspond to more than one interface.
10. The computer-readable medium of any of aspects 1-9, wherein the operations further comprise: obtaining training data including outputs of execution instances of a plurality of interfaces, characteristics of the plurality of interfaces, and a security risk score for each of the plurality of interfaces; training a machine learning model, using the training data, to predict a security risk score of a new interface based on characteristics of the new interface and an output of an execution instance of the new interface; and providing a recommendation for interface modification or computing system modification based on the security risk score of the new interface.
11. The computer-readable medium of aspect 10, wherein the operations further comprise: generating a recommendation for interface modification of at least one of the plurality of interfaces and the new interface based on the security risk score.
12. The computer-readable medium of any of aspects 10-11, wherein the operations further comprise: generating a recommendation for computing system modification to block access of at least one of the plurality of interfaces and the new interface based on the security risk score.
13. The computer-readable medium of any of aspects 10-12, wherein the operations further comprise automatically implementing the recommendation.
14. The computer-readable medium of aspect 13, wherein the operations further comprise automatically implementing the recommendation if the security risk score indicates a high severity risk.
15. The computer-readable medium of any of aspects 1-14, wherein the operations further comprise: evaluating the extent to which the interface complies with a plurality of security policies.
16. The computer-readable medium of aspect 15, wherein the operations further comprise: generating a weighted risk score by generating a weighted sum of extents to which the interface complies with the plurality of security policies, a weight being defined for each element of the weighted sum based on a severity of a risk associated with violating each respective security policy.
17. The computer-readable medium of aspect 16, wherein the operations further comprise: obtaining training data including characteristics of historical security policies, and a severity of effects of violating each of the historical security policies; training a machine learning model, using the training data, to predict a severity of security effects of violating a new security policy based on characteristics of the new security policy; and assigning the weight to the new security policy based on the severity.
18. A system comprising one or more processors, and one or more non-transitory memories storing computer-readable instructions for monitoring security compliance in a computing system that, when executed by one or more processors, cause the one or more processors to: execute at least one function of an interface, the at least one function invoked by a device outside the computing system, to generate policy execution outputs, the interface comprising executable code segments that, when executed, access information within at least a portion of the computing system; evaluate an extent to which the interface complies with a security policy associated with the computing system based on the policy execution outputs; and provide an alert if the extent to which the interface complies with the security policy fails to meet a threshold and accessing a database to log the extent or details of the executing of the at least one function otherwise.
19. The system of aspect 18, wherein: the security policy comprises a rule or a condition to be met by the interface; and the security policy is associated with a component within which or through which the interface executes.
20. The system of aspect 19, wherein: the interface comprises an application programming interface (API) or a portion thereof; and the component comprises an API gateway, a Domain Name System (DNS) resolution component, or a continuous integration and continuous deployment (CI/CD) pipeline.
21. The system of aspect 19, wherein the computer-readable instructions further cause the one or more processors to: generate an execution script to execute at least one interface under a plurality of security policies; and determine security compliance of the at least one interface throughout execution of at least a portion of the execution script.
22. The system of aspect 21, wherein: generating the execution script comprises determining dependencies between a first policy of the execution script and a second policy of the execution script; generating the execution script such that the first policy and the second policy execute simultaneously or sequentially depending on whether there are dependencies between the first policy and the second policy; the execution script includes policies that correspond to more than one component; and the execution script includes policies that correspond to more than one interface function.
23. The system of any of aspects 18-22, wherein the computer-readable instructions further cause the one or more processors to: obtain training data including outputs of execution instances of a plurality of interface functions, characteristics of the plurality of interface functions, and a security risk score for each of the plurality of interface functions; train a machine learning model, using the training data, to predict a security risk score of a new interface function based on characteristics of the new interface function and an output of an execution instance of the new interface function; and provide a recommendation for interface function modification or computer system modification based on the security risk score of the new interface function.
24. The system of aspect 23, wherein the computer-readable instructions further cause the one or more processors to generate a recommendation for interface function modification of at least one of the plurality of interface functions and the new interface function based on the security risk score; and automatically implement the recommendation if the security risk score is above a threshold.
25. The system of any of aspects 18-24, wherein the computer-readable instructions further cause the one or more processors to: evaluate the extent to which the interface complies with a plurality of security policies by generating a weighted sum of extents to which the interface complies with the plurality of security policies, a weight being defined for each element of the weighted sum based on a severity of a risk associated with violating each respective security policy.
26. The system of aspect 25, wherein the computer-readable instructions further cause the one or more processors to: obtain training data including results of executing a plurality of interface functions against one or more security policies, and a severity of effects of violating each of the one or more security policies; train a machine learning model, using the training data, to predict a severity of security effects of violating a new security policy based on results of executing the plurality of interface functions against the new security policy; assign the weight based on the severity; and provide the weighted sum to a display.
27. A computer-implemented method for monitoring security compliance in a computing system, the method comprising: executing at least one function of an interface, the at least one function invoked by a device outside the computing system, to generate policy execution outputs, the interface comprising executable code segments that, when executed, access information within at least a portion of the computing system; evaluating an extent to which the interface complies with a security policy associated with the computing system based on the policy execution outputs; and providing an alert if the extent to which the interface complies with the security policy fails to meet a threshold and accessing a database to log the extent or details of the executing of the at least one function otherwise.
28. The computer-implemented method of aspect 27, wherein: the security policy comprises a rule or a condition to be met by the interface; and the security policy is associated with a component within which or through which the interface executes.
29. The computer-implemented method of aspect 28, wherein: the interface comprises an application programming interface (API) or portion thereof; and the component comprises an API gateway.
30. The computer-implemented method of any of aspects 27-29, wherein the component comprises a Domain Name System (DNS) resolution component.
31. The computer-implemented method of any of aspects 27-30, wherein the component comprises a continuous integration and continuous deployment (CI/CD) pipeline.
32. The computer-implemented method of any of aspects 27-31, further comprising: generating an execution script to execute at least one interface under a plurality of security policies; and determining security compliance of the at least one interface throughout execution of at least a portion of the execution script.
33. The computer-implemented method of aspect 32, wherein: generating the execution script comprises determining dependencies between a first policy of the execution script and a second policy of the execution script; and generating the execution script such that the first policy and the second policy execute simultaneously or sequentially depending on whether there are dependencies between the first policy and the second policy.
34. The computer-implemented method of any of aspects 32-33, wherein: the execution script includes policies that correspond to more than one component.
35. The computer-implemented method of any of aspects 32-34, wherein: the execution script includes policies that correspond to more than one interface.
36. The computer-implemented method of any of aspects 27-35, further comprising: obtaining training data including outputs of execution instances of a plurality of interfaces, characteristics of the plurality of interfaces, and a security risk score for each of the plurality of interfaces; training a machine learning model, using the training data, to predict a security risk score of a new interface based on characteristics of the new interface and an output of an execution instance of the new interface; and providing a recommendation for interface modification or computing system modification based on the security risk score of the new interface.
37. The computer-implemented method of aspect 36, further comprising: generating a recommendation for interface modification of at least one of the plurality of interfaces and the new interface based on the security risk score.
38. The computer-implemented method of aspect 36, further comprising: generating a recommendation for computing system modification to block access of at least one of the plurality of interfaces and the new interface based on the security risk score.
39. The computer-implemented method of aspect 38, further comprising automatically implementing the recommendation.
40. The computer-implemented method of aspect 39, further comprising automatically implementing the recommendation if the security risk score indicates a high severity risk.
41. The computer-implemented method of any of aspects 27-40, further comprising: evaluating the extent to which the interface complies with a plurality of security policies.
42. The computer-implemented method of aspect 41, further comprising: generating a weighted risk score by generating a weighted sum of extents to which the interface complies with the plurality of security policies, a weight being defined for each element of the weighted sum based on a severity of a risk associated with violating each respective security policy.
43. The computer-implemented method of aspect 42, further comprising: obtaining training data including results of executing a plurality of interfaces against one or more security policies, and a severity of effects of violating each of the one or more security policies; training a machine learning model, using the training data, to predict a severity of security effects of violating a new security policy based on results of executing the plurality of interfaces against the new security policy; assigning the weight based on the severity; and providing the weighted risk score to a display.

### ADDITIONAL CONSIDERATIONS

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, non-transitory or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for adaptive intelligent user validation. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-readable medium including instructions that, when executed on a processor, cause the processor to perform operations for monitoring security compliance in a computing system, the operations comprising:
generating an execution script to execute at least one function of an interface under a plurality of security policies, the at least one function being invoked by a device outside the computing system and the interface comprising executable code segments that, when executed, access information within at least a portion of the computing system;
executing the execution script to generate policy execution outputs;
evaluating an extent to which the interface complies with the plurality of security policies associated with the computing system based on the policy execution outputs; and
providing an alert if the extent to which the interface complies with the plurality of security policies fails to meet a threshold and accessing a database to log the extent or details of the executing of the at least one function otherwise.

2. The computer-readable medium of claim 1, wherein:
a security policy of the plurality of security policies comprises a rule or a condition to be met by the interface and is associated with at least one component within which or through which the interface executes;
the interface comprises an application programming interface (API) or a portion thereof; and
the at least one component comprises an API gateway, a Domain Name System (DNS) resolution component or a continuous integration and continuous deployment (CI/CD) pipeline.

3. The computer-readable medium of claim 2, wherein the operations further comprise:
determining security compliance of the at least one function of the interface throughout execution of at least a portion of the execution script.

4. The computer-readable medium of claim 3, wherein the operations further comprise:
generating a weighted risk score by generating a weighted sum of extents to which the interface complies with the plurality of security policies, a weight being defined for each element of the weighted sum based on a severity of a risk associated with violating each respective security policy.

5. The computer-readable medium of claim 4, wherein the operations further comprise:
obtaining training data including characteristics of historical security policies, and a severity of effects of violating each of the historical security policies;
training a machine learning model, using the training data, to predict a severity of security effects of violating a new security policy based on characteristics of the new security policy; and
assigning the weight to the new security policy based on the severity.

6. The computer-readable medium of claim 1, wherein the operations further comprise:
obtaining training data including outputs of execution instances of a plurality of interfaces, characteristics of the plurality of interfaces, and a security risk score for each of the plurality of interfaces;
training a machine learning model, using the training data, to predict a security risk score of a new interface based on characteristics of the new interface and an output of an execution instance of the new interface; and
providing a recommendation for interface modification or computing system modification based on the security risk score of the new interface.

7. The computer-readable medium of claim 6, wherein the operations further comprise:
generating a recommendation for interface modification of at least one of the plurality of interfaces and the new interface based on the security risk score;
generating a recommendation for computing system modification to block access of at least one of the plurality of interfaces and the new interface based on the security risk score; and
automatically implementing at least one of the recommendation for interface modification or the recommendation for computing system modification.

8. A system comprising one or more processors, and one or more non-transitory memories storing computer-readable instructions for monitoring security compliance in a computing system that, when executed by one or more processors, cause the one or more processors to:
generate an execution script to execute at least one function of an interface under a plurality of security policies, the at least one function being invoked by a device outside the computing system and the interface comprising executable code segments that, when executed, access information within at least a portion of the computing system;
execute the execution script to generate policy execution outputs;
evaluate an extent to which the interface complies with the plurality of security policies associated with the computing system based on the policy execution outputs; and
provide an alert if the extent to which the interface complies with the plurality of security policies fails to meet a threshold and accessing a database to log the extent or details of the executing of the at least one function otherwise.

9. The system of claim 8, wherein:
a security policy of the plurality of security policies comprises a rule or a condition to be met by the interface and is associated with at least one component within which or through which the interface executes;
the interface comprises an application programming interface (API); and
the at least one component comprises an API gateway, a Domain Name System (DNS) resolution component, or a continuous integration and continuous deployment (CI/CD) pipeline.

10. The system of claim 8, wherein the computer-readable instructions further cause the one or more processors to:
determine security compliance of the at least one function of the interface throughout execution of at least a portion of the execution script.

11. The system of claim 8, wherein the computer-readable instructions further cause the one or more processors to:
obtain training data including outputs of execution instances of a plurality of interfaces, characteristics of the plurality of interfaces, and a security risk score for each of the plurality of interfaces;
train a machine learning model, using the training data, to predict a security risk score of a new interface based on characteristics of the new interface and an output of an execution instance of the new interface; and
provide a recommendation for interface modification or computer system modification based on the security risk score of the new interface.

12. The system of claim 11, wherein the computer-readable instructions further cause the one or more processors to:
generate a recommendation for interface modification of at least one of the plurality of interfaces and the new interface based on the security risk score; and
automatically implement the recommendation if the security risk score is above a threshold.

13. The system of claim 8, wherein the computer-readable instructions further cause the one or more processors to:
evaluate the extent to which the interface complies with a plurality of security policies by generating a weighted sum of extents to which the interface complies with the plurality of security policies, a weight being defined for each element of the weighted sum based on a severity of a risk associated with violating each respective security policy.

14. The system of claim 13, wherein the computer-readable instructions further cause the one or more processors to:
obtain training data including characteristics of historical security policies, and a severity of effects of violating each of the historical security policies;
train a machine learning model, using the training data, to predict a severity of security effects of violating a new security policy based on characteristics of the new security policy;
assign the weight to the new security policy based on the severity; and
provide the weighted sum to a display.

15. A computer-implemented method for monitoring security compliance in a computing system, the method comprising:
generating an execution script to execute at least one function of an interface under a plurality of security policies, the at least one function being invoked by a device outside the computing system and the interface comprising executable code segments that, when executed, access information within at least a portion of the computing system;
executing the execution script to generate policy execution outputs;
evaluating an extent to which the interface complies with the plurality of security policies associated with the computing system based on the policy execution outputs; and
providing an alert if the extent to which the interface complies with the plurality of security policies fails to meet a threshold and accessing a database to log the extent or details of the executing of the at least one function otherwise.

16. The computer-implemented method of claim 15, wherein:
a security policy of the plurality of security policies comprises a rule or a condition to be met by the interface and is associated with at least one component within which or through which the interface executes;
the interface comprises an application programming interface (API) or a portion thereof; and
the at least one component comprises an API gateway, a Domain Name System (DNS) resolution component or a continuous integration and continuous deployment (CI/CD) pipeline.

17. The computer-implemented method of claim 16, further comprising:
determining security compliance of the at least one function of the interface throughout execution of at least a portion of the execution script.

18. The computer-implemented method of claim 17, further comprising:
generating a weighted risk score by generating a weighted sum of extents to which the interface complies with the plurality of security policies, a weight being defined for each element of the weighted sum based on a severity of a risk associated with violating each respective security policy:
obtaining training data including characteristics of historical security policies, and a severity of effects of violating each of the historical security policies;
training a machine learning model, using the training data, to predict a severity of security effects of violating a new security policy based on characteristics of the new security policy; and
assigning the weight to the new security policy based on the severity.

19. The computer-implemented method of claim 15, further comprising:
obtaining training data including outputs of execution instances of a plurality of interfaces, characteristics of the plurality of interfaces, and a security risk score for each of the plurality of interfaces;
training a machine learning model, using the training data, to predict a security risk score of a new interface based on characteristics of the new interface and an output of an execution instance of the new interface; and
providing a recommendation for interface modification or computing system modification based on the security risk score of the new interface.

20. The computer-implemented method of claim 19, further comprising:
generating a recommendation for interface modification of at least one of the plurality of interfaces and the new interface based on the security risk score;
generating a recommendation for computing system modification to block access of at least one of the plurality of interfaces and the new interface based on the security risk score; and
automatically implementing at least one of the recommendation for interface modification or the recommendation for computing system modification.
